(19) United States
(12) Patent Application Publication
(10) Pub. No.: US 2002/0159401 A1
(43) Pub. Date: Oct. 31, 2002

(54) Masterless slave / master role switch in a bluetooth piconet

(75) Inventor: Yoel Boger, Shoham (IL)

Correspondence Address: DR. MARK FRIEDMAN LTD., c/o ANTHONY CASTORINA, SUITE 207, 2001 JEFFERSON DAVIS HIGHWAY, ARLINGTON, VA, 22202, US

(73) Assignee: BRIGHTCOM TECHNOLOGIES LTD.

(21) Appl. No.: 09/840,891

(22) Filed: Apr. 25, 2001

(51) Int. Cl. H04L 5/14

(52) U.S. Cl. 370/294; 370/338

(57) ABSTRACT

The present invention discloses a method by which a new Bluetooth piconet is established amongst participants of an old Bluetooth piconet whose master has disappeared. After determining that the master has disappeared, one of the slaves is selected to take the function of the master and reestablishes communications at the Baseband layer by contacting each of the other participants. Further, the present invention discloses a method and an associated device for realizing point-to-multipoint communications using a Bluetooth piconet by using an application adaptation layer and a local addressing list. Also, the present invention discloses a method by which point-to-multipoint communications by an application using a Bluetooth piconet is reestablished amongst participants of an old Bluetooth piconet whose master has disappeared. After reestablishing the piconet at the Baseband layer, communications at higher layers of the Bluetooth protocol stack are reestablished from the bottom up, that is, reestablishing communications at the LM layer precedes reestablishing communications at the L2CAP layer.

### FIELD AND BACKGROUND OF THE INVENTION

The present invention relates to hierarchy designation within a Bluetooth piconet, and more specifically to selection of a master when the Master/Slave switch is impossible due to master disappearance. The present invention also relates to the re-establishment of point-to-multipoint communications within a Bluetooth piconet after master disappearance.

Bluetooth is a computing and telecommunications industry specification that describes how various electronic devices such as mobile phones, computers, and personal digital assistants can interconnect and communicate with each other. Ericsson Mobile Communications (Stockholm, Sweden) conceived Bluetooth in 1994 as a protocol enabling wireless communication to peripheral devices. With the establishment of a “special interest group” in 1998, Bluetooth became an accepted standard, opening the way to development of technology that allows various devices to intercommunicate.

To intercommunicate via the Bluetooth protocol, devices must be Bluetooth enabled, that is, they must be equipped with a transceiver that transmits and receives in a 2.45 Ghz frequency band. Every Bluetooth enabled device has a 48-bit address called the BD_ADDR (Bluetooth device address) that uniquely identifies the device.

Although the Bluetooth protocol uses point-to-point connectivity, its topology is based on ad hoc networks called piconets. A piconet is defined as a network of one master and one or more slaves. Up to seven slaves can be active at any one time.

Communication within a piconet is based on a Time-Division Duplex (TDD) scheme. Time is divided into slots of 625 microseconds. Transmission begins only at the beginning of a slot and occurs within a period of one or more slots. Devices transmit sequentially using a synchronous query-response scheme. Master transmissions start exclusively at even-numbered slots and slave transmissions start exclusively at odd-numbered slots. During a slot or an odd multiple of slots, information is transmitted as a packet. Rather than transmitting at one constant frequency, frequency hopping amongst 79 frequencies at a rate of 1600 hops/s is used.

The master is the most important entity in the piconet. The frequency hopping scheme and the channel access code of a piconet is defined based on the BD_ADDR of the master of the piconet. The system clock of the master determines the phase in the hopping sequence. During formation of the piconet the master assigns each slave an AM_ADDR (active member address), an integer from 1 through 7, which uniquely identifies the slave within the piconet. All parameters necessary for communications in the piconet taken together are called the communication parameters and include the frequency hopping scheme and the channel access code.

Once a piconet has been established, all members of the piconet must be synchronized and must have an identical time reference, that is when a slot begins and how long a slot is. To do this, all slaves continuously monitor the system clock of the master and correct their individual clocks with an offset to match the master's system clock.

The master acts as the hub of the piconet. The master initiates a communication to a specific slave and allocates a slot or slots during which that slave can reply. During the allocated slot or slots, the slave replies. Slaves communicate only in slots allocated by the master.

Transmission is done in packets. Each packet is made up of three parts: an access code, a packet header and a payload. The access code includes synchronization information and a code for identifying the transmission as belonging to a piconet or as being a step in the piconet formation process. The packet header includes information for packet acknowledgement and the AM_ADDR of the device for which the packet is intended. The payload contains the transmitted data and, optionally, a data header.

Each device operating under the Bluetooth protocol has an internal hierarchy, the Bluetooth protocol stack. Each layer of the stack is implemented as hardware, software or a combination thereof. A Bluetooth protocol stack is depicted in FIG. 1.

The lowest layer is a RF transceiver 10. Overlaying RF transceiver 10 is a Baseband layer 12. Baseband layer 12 manages physical channels and links. The Baseband protocol is implemented as a link controller, and works with a Link Manager layer 14 (LM) for carrying out link level routines like link connection. Baseband layer 12 handles packets and applies the TDD scheme. Overlaying Baseband layer 12 is LM 14. LM 14 carries out link setup, authentication, link configuration and other protocols.

Overlaying LM 14 is a Logical Link Control and Adaptation Protocol (L2CAP) layer 16. L2CAP 16 provides the connection-oriented and connectionless data services to upper layer protocols with protocol multiplexing capability, segmentation and reassembly operations and group abstractions. Overlaying L2CAP 16 is application layer 18, the program that the operator of the device uses.

Each layer of a device communicates with the corresponding layer of another device, that is, for example, the L2CAP layer of a device 1 sends information to the L2CAP layer of a device 2.

Piconet formation is a well-defined sequential process that occurs between the Baseband layers of the devices and is described by way of the following example. The Bluetooth-enabled devices unit 0 and unit 1 are activated and are within range of each other. Unit 0 issues an Inquire packet using an inquiry frequency-hopping scheme. Since unit 0 issues the Inquire transmission it is by definition the unit which shall be master of the incipient piconet. Unit 1 is in a discoverable mode (inquiry scan state). Since unit 1 is receiving the Inquire transmission it is by definition the unit which shall be a slave in the incipient piconet. Unit 1 receives the Inquire transmission and responds with an FHS packet, which has the BD_ADDR and clock setting of unit 1.

Unit 0 pages unit 1 using the BD_ADDR and, optionally, the clock setting of unit 1. If it is in a connectable mode, unit 1 enters a slave response state and sends a first reply to unit 0. Unit 0 sends an FHS packet with its own BD_ADDR and its clock setting to unit 1. Unit 1 sends a second reply, confirming receipt of the FHS packet. The active slave state, the AM_ADDR and the BD_ADDR of unit 1 are noted in the table of active links of unit 0. In the table of active links of unit 1 the master status, the BD_ADDR and clock offset of unit 0 are noted.

After these steps, a piconet exists where unit 0 is the master and unit 1 is the slave. Further intrapiconet communication is done using the communication parameters of the piconet, that is a frequency hop scheme calculated from the master BD_ADDR with a phase determined by the clock of the master. The slave adapts its own clock with a timing offset to match the clock of the master. Further, transmissions in the piconet include a channel access code (CAC) derived from the master BD ADDR to identify the packet as belonging to the piconet.

If other devices are in range, unit 0 can repeat the process above until a maximum of seven AM_ADDRs have been assigned to seven different devices. The master of a piconet uses the AM_ADDR to direct a packet to one of the slaves of the piconet. A slave responds only to packets addressed to it.

According to the Bluetooth protocol it is possible for a master and a slave to switch roles. During an allocated slot, the master or a slave transmits a LMP_Switch_Req command requesting that the slave become the master of the piconet. If the switch is agreed to by transmission of a LMP_accepted command, a role switch is performed.

Consider a piconet wherein a unit 0 is the master, designated m0, and unit 1 and unit 2 both are slaves designated s1 and s2, respectively. m0 and s1 agree to exchange roles, whereby s1 shall become the new master m1 and the master m0 shall become a slave, s0. m0 and s1 continue using the communication parameters of the original piconet (the frequency hopping scheme based on the unit 0 BD_ADDR and clock), but perform a time-division switch, that is unit 1 transmits starting at even-numbered slots and unit 0 starting at odd-numbered slots.

The first step is to realign slot boundaries according to the clock of the new master m1 (unit 1). This is done by a LMP_slot_offset command sent from the new master m1 (unit 1) to the slave s0 (unit 0). The new master m1 (unit 1) sends an FHS packet assigning a new AM_ADDR to the new slave s0 (unit 0). The slave s0 (unit 0) transmits an ID packet to acknowledge the receipt of the FHS packet. Both the new master (m1) unit 1 and the slave s0 (unit 0) thereafter switch to use the slot boundaries, frequency hopping and timing as dictated by the new master. Unit 0 then transfers the AM_ADDRs and other salient information concerning the other slaves of the piconet to the new master (unit 1).

Unit 1 further enforces a piconet switch on each slave separately. The new slot alignment offset, the new AM_ADDR and other information are sent to each slave using the original piconet communication parameters. Upon acknowledgment, that slave switches to the new piconet communication parameters, as dictated by unit 1.

At anytime after establishing communications, a master and a slave can negotiate a time-out period (Supervision Time Out). After receipt of each packet, the timer dedicated to the time-out period is reset to zero. If one of the two devices does not receive any packets from the other within the time-out period, that device assumes that the link to the other device has been lost and the other device is deleted from its table of active links.

It can occur that for some reason the master of the piconet disappears. This happens if the master experiences a power blackout, is physically damaged or is turned off by the user. In the existing Bluetooth protocol, every slave of the piconet would continue anticipating a transmission from the master. Without a master acting as the hub of the piconet, information cannot be transferred and the piconet ceases to function. As each slave successively reaches its own time-out period without receiving any packets from the master, it stops to be a slave in the piconet and ultimately the piconet ceases to exist.

There are instances when this situation is undesirable. For example, in a multiplayer game played through a Bluetooth piconet, the participants who were slaves may want to continue playing the game despite the unexpected disappearance of the device designated as master of the piconet.

There is a need for a method that allows a Bluetooth piconet to continue functioning after the master of the piconet unexpectedly disappears. There must be method to reconstitute the piconet in a way that is transparent to the user and to the application.

### SUMMARY OF THE INVENTION

The above and other objectives are achieved by the innovative methods and the innovative device provided by the present invention.

As described above, the Bluetooth protocol allows establishment of a Bluetooth piconet where the master acts as a hub for all communications between units of the piconet. If the master disappears, communications between all other units ceases. The use of the teachings of the present invention allows a piconet to be established using the slaves of a Bluetooth piconet of which the master has disappeared.

Further, there exist applications that rely on point-to-multipoint communications. In such cases it is preferable that the point-to-point topology of the piconet be hidden from the application. The use of the teachings of the present invention allows an application that relies on point-to-multipoint communications to use a Bluetooth piconet without needing any knowledge of the piconet. Furthermore, the use of the teachings of the present invention allows such an application to continue running with only slave units when the master of the piconet disappears without the application knowing that the master has disappeared.

According to the teachings of the present invention there is provided a method of establishing a new Bluetooth piconet amongst the slaves of an old Bluetooth piconet after the disappearance of the master of the old Bluetooth piconet by a) determining that the master has disappeared; b) selecting one of the slaves to be a new master; and c) establishing the new Bluetooth piconet by the new master at the Baseband layer.

According to a further feature of the present invention, the disappearance of the master is determined by each slave independently waiting a period of time after cessation of transmissions from the old master, and where the first slave that completes waiting its period of time is selected as the new master.

According to a still further feature of the present invention, the period of time each slave waits is predetermined and/or identical for all slaves.

According to a still further feature of the present invention, each slave is configured to start waiting its period of time at a different moment.

According to a further feature of the present invention, each slave has a) a first timer set to overflow after counting a first period of time and to reset upon receipt of a transmission from the old master to that slave; b) a second timer configured to start counting when the first timer overflows, to overflow after counting a second period of time and to reset upon receipt of transmission from the old master to any slave; and wherein the slave whose second timer overflows first is selected as said new master. It is often preferable that the second period of time is at least as great as the first period of time to guarantee that the old master has truly disappeared from the piconet and has not just moved out of transmission range of one of the slaves.

There is also provided according to the teachings of the present invention a method for establishing a new Bluetooth piconet amongst the slaves of an old Bluetooth piconet after the disappearance of the old master of the old Bluetooth piconet by a) selecting one of the slaves to be a new master; b) designating the other slaves of the old Bluetooth piconet as slaves of the new Bluetooth piconet; c) the new master transmitting new communication parameters for the new Bluetooth piconet sequentially to each of the new slaves beginning at slots reserved for master transmissions using communication parameters of the old piconet; and d) switching each of the slaves to use the new communication parameters.

According to a further feature of the present invention each slave switches to use the new communication parameters upon receipt of the new communication parameters from the new master. Alternatively, according to a further feature of the present invention each slave has a) a first timer set to overflow after counting a first period of time and to reset upon receipt of a transmission from the old master to that slave; and b) a flag which is set to TRUE when the first timer overflows and the flag is set to FALSE upon receipt of any transmission from the old master; and wherein a slave switches to the new communication parameters upon receipt thereof from said new master only if said flag is set to TRUE.

According to a further feature of the present invention, the new master transmits the new communication parameters to each AM_ADDR of the possible AM_ADDRs with the exception of the old AM_ADDR of the new master. Alternatively, according to a further feature of the present invention, the new master transmits the new communication parameters only to AM_ADDRs that were assigned in the old piconet.

According to a further feature of the present invention the new master assigns a new AM_ADDR to each of the slaves joining the new piconet, where preferably the new AM_ADDR of each slave is identical to its AM_ADDR in the original piconet.

There is also provided according to the teachings of the present invention a Bluetooth enabled device configured to allow point-to-multipoint communications by an application between at least two units using a Bluetooth piconet by using an application adaptation layer. The application adaptation layer receives packets from the application wherein each packet is labeled with a name of the source unit and the name of the destination unit and the application does not need to be aware of the existence of the piconet.

According to a further feature of the present invention, the device also has a local addressing list accessible to the application adaptation layer. The local addressing list contains at least the name and the AM_ADDR of all other units participating in the Bluetooth piconet.

According to a further feature of the present invention, the local addressing list is accessible to the L2CAP layer. In this case, the local addressing list also contains the LCIDs corresponding to the logical links between the L2CAP layer of the device and the L2CAP layer of other units participating in the Bluetooth piconet.

According to a further feature of the present invention, the local addressing list is accessible to the LM layer. In this case, the local addressing list also contains the CHs corresponding to the logical links between the LM layer of the device and the LM layer of other units participating in the Bluetooth piconet.

There is also provided according to the teachings of the present invention a method of restoring point-to-multipoint communications by an application amongst the slaves of an old Bluetooth piconet after the disappearance of the master of the old Bluetooth piconet by a) determining that the master has disappeared; b) selecting one of the slaves to be a new master; and c) establishing the new Bluetooth piconet by the new master at the Baseband layer; and d) establishing communications between the units at at least one layer of the Bluetooth protocol stack other then the Baseband layer.

According to a further feature of the present invention, the application is informed of the disappearance of the master of the old piconet.

According to a further feature of the present invention, the Baseband layer of a unit informs its respective LM layer of the fact that a new Bluetooth piconet has been established.

According to a further feature of the present invention, the LM layer of a unit informs its respective L2CAP layer of the fact that a new Bluetooth piconet has been established.

According to a further feature of the present invention, the new master is the unit that establishes communications between the units at the layers of the Bluetooth protocol stack other then the Baseband layer. The new master establishes the communications either serially, that communications are established at all relevant layers of one unit before communications are established with another unit, or in parallel, where the communications are established to one layer with a number of units, before proceeding to establishing communications with other levels.

According to a further feature of the present invention, the relevant layers include at least the LM and the L2CAP layers. According to a still further feature of the present invention, establishing communications with the LM layer of a unit precedes establishing communications with the L2CAP layer of that unit.

### BRIEF DESCRIPTION OF THE DRAWINGS

The invention is herein described, by way of example only, with reference to the accompanying drawings, where:

FIG. 1 (prior art) is a schematic description of a Bluetooth protocol stack;

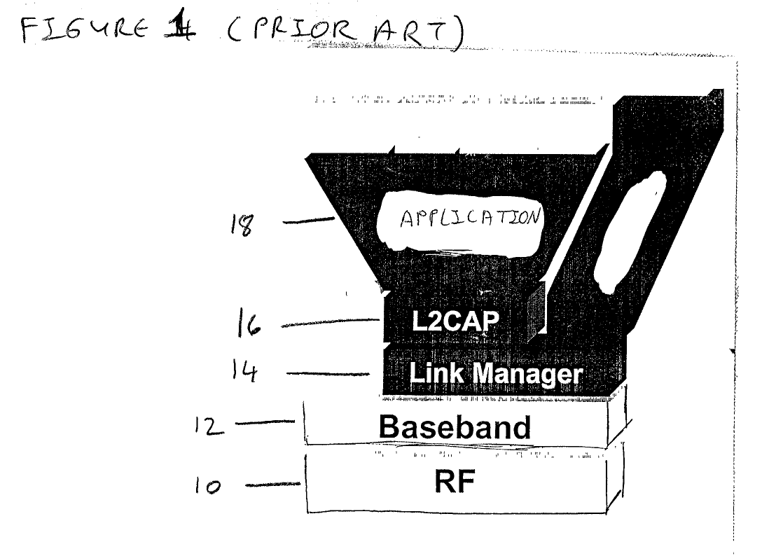

FIG. 2 shows the process of selecting a slave to perform the masterless slave to master role switch according to the present invention;

FIG. 3 shows the process of a new master reconstituting a piconet during the masterless slave to master role switch according to the present invention;

FIGS. 4a-4d are the addressing tables according to the present invention of a piconet composed of a master and three slaves;

FIG. 5 is the flow of a packet that is transmitted by one slave to a second slave according to the present invention;

FIG. 6 shows the sequential changes occurring in the addressing tables of a piconet during piconet reconstitution; and

FIG. 7 is a schematic description of the protocol stack of a device of the present invention.

### DETAILED DESCRIPTION OF THE INVENTION

The principles and use of the methods according to the present invention may be better understood with reference to the drawings and the accompanying description. Before turning to details of the present invention, it should be appreciated that the present invention provides two sets of features, which when combined provide a particularly useful method.

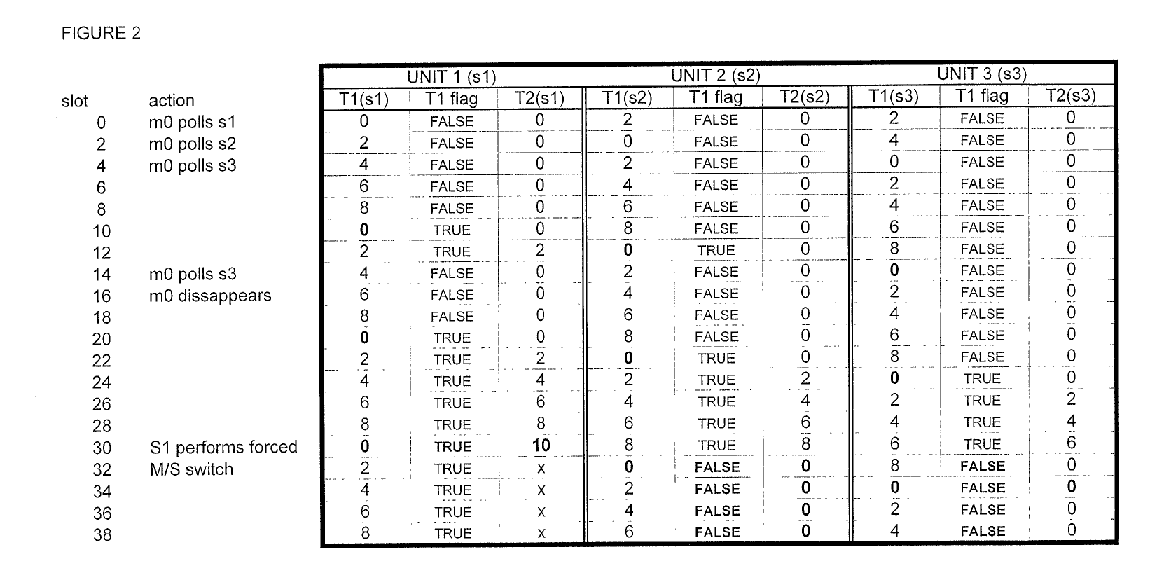

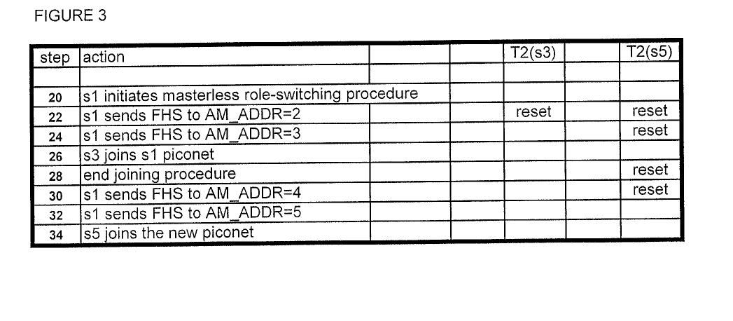

The first feature relates to a method whereby a slave of a Bluetooth piconet performs a masterless role-switch after disappearance of the master. The first feature will be described with particular reference to FIGS. 2 and 3.

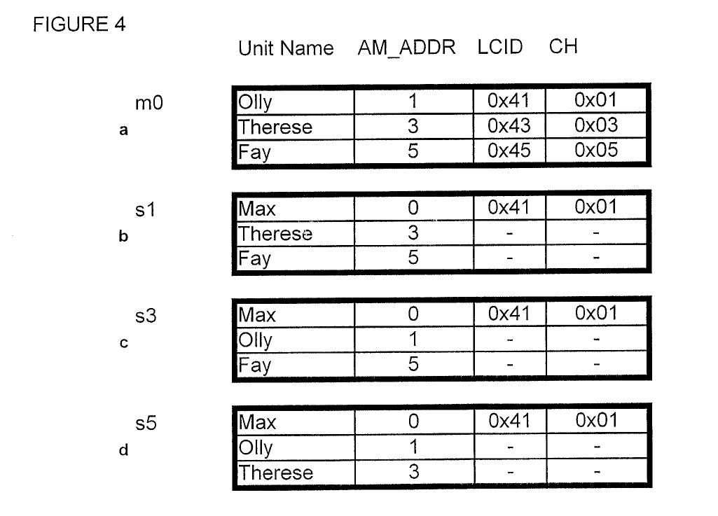

The second feature relates to a method that allows a point-to-multipoint application running on a Bluetooth piconet to continue functioning after disappearance of the piconet master. The second features will be described with reference to FIGS. 4 through 6.

Recovery from the loss of the piconet master consists of the steps of designating one of the slaves as the new master followed by imposition of this new designation on the other slaves.

As described above, each device in a piconet has a time out parameter (T_supervision) which is the time used to decide if a master-slave link is lost. According to the first feature of the present invention, T_supervision is identical for all slaves in the piconet. Additionally, each slave device of the piconet is equipped with at least two timers, T1 and T2, and a T1_flag.

T1 is a timer used to count T_supervision and is reset each time the slave receives a transmission addressed to it from the master. T1 overflows when T_supervision is reached. Once T1 has overflowed it is reset to zero and begins counting anew. The T1_flag is set to TRUE. The T1_flag is set to FALSE any time the slave receives a packet sent by the master to any one of the slaves of the piconet, including itself.

T2 begins counting when T1 overflows. T2 is reset any time the slave receives a packet sent by the master to any one of the slaves of the piconet, including itself.

Once reset, T2 resumes counting only when T1 again overflows.

T2 overflows when a predetermined number of N slots is reached. All slaves in the piconet have the same value of N. When the T2 counter of a slave overflows, that slave initiates the masterless role-switching procedure.

This arrangement of two counters ensures that a reasonable delay is maintained before a masterless role-switching procedure is initiated and that no two T2 counters of one piconet can overflow at the same time.

The counting of the T1 and T2 timers in a piconet composed of one master m0 and three slaves, s1, s2 and s3 is schematically depicted in FIG. 2. All timers T1 and T2 are set to overflow after counting ten slots (T_supervision=N=10).

At slots 0, 2 and 4 s1, s2 and s3 are respectively polled by the master, m0, resetting T1(s1), T1(s2) and T1(s3).

At slot 10 T1(s1) overflows and T1_flag(s1)=TRUE. T1(s1) is reset and T2(s1) begins counting.

At slot 12 T1(s2) overflows and T1_flag(s2)=TRUE. T1(s2) is reset and T2(s2) begins counting.

At slot 14 m0 polls s3. T1(s3) is reset. T1_flag(s1)=FALSE and T1_flag(s2)=FALSE. T2(s1) and T2(s2) are reset.

At slot 16, m0 disappears and no longer transmits information.

At slot 20, T1(s1) overflows and T1_flag(s1)=TRUE. T1(s1) is reset and T2(s1) begins counting.

At slot 22, T1(s2) overflows and T1_flag(s2)=TRUE. T1(s2) is reset and T2(s2) begins counting.

At slot 24, T1(s3) overflows and T1_flag(s3)=TRUE. T1(s3) is reset and T2(s3) begins counting.

At slot 30, T2(s1) overflows. Since T1_flag(s1)=TRUE, s1 initiates the masterless role-switching procedure according to the first feature of the present invention.

The slave initiating the masterless role-switching, procedure, s1, first performs a time-division switch and begins to transmit starting at even-numbered slots, being the slots reserved exclusively for use by the piconet master using the original piconet slot boundaries and original piconet frequency hopping scheme. The first packet transmitted by the slave initiating the masterless role-switch will reset the T2 timer of all the slaves of the piconet and thus will avoid a situation where another slave will also attempt to initiate a masterless role switch. The slave s1 attempts to switch all the potential slaves of the former piconet using each one of the six available AM_ADDRs, the seventh being its own original AM_ADDR. In the present example, the piconet switch will be acknowledged only for AM_ADDRs 2 and 3, corresponding to slaves s2 and s3, respectively.

Just as in a standard master-slave role switch, each FHS packet is addressed to a slave using its original AM_ADDR. In the packet payload, the new slot alignment offset, the new AM_ADDR and other information is sent to each slave using the original piconet parameters. In principle, the new master can allocate new AM_ADDRs to each one of the slaves that joins the new piconet. It is however preferable that the slaves retain the same AM_ADDR in the new piconet as in the original piconet.

In a first embodiment of the first feature of the present invention the addressed slave acknowledges receipt of the FHS packet immediately and switches to the new piconet parameters as dictated by the new master.

In a second embodiment of the first feature of the present invention the addressed slave checks its own T1_flag. If the T1_flag is FALSE it means that as far as that unit is concerned, the original master is still functioning and piconet integrity is not compromised. In such a case it does not accept the piconet switch. If the T1_flag is TRUE the slave acknowledges receipt of the FHS packet, and switches to the new piconet parameters, as dictated by the new master. In this embodiment an unnecessary master/slave switch is prevented, for example, in a situation when a slave moves out of the transmission range of the master and tries to switch the other slaves to its piconet. In this embodiment it is necessary that T2 is greater than or equal to T1. This is necessary to ensure that when the old master truly disappears there is enough time for the T1 flags of all slaves to be set to TRUE before an FHS packet from the slave that has initiated the forced master/slave switch is transmitted.

Once an acknowledgment packet is sent from a second unit to a first unit initiating the masterless role switching, then the second unit is part of the new piconet. If no acknowledgment is received then the first unit assumes that that specific AM_ADDR is unassigned in the original piconet and the first unit continues querying the succeeding AM_ADDR until all six AM_ADDRs have been queried.

The second embodiment of the first feature of the present invention can be better understood by reference to FIG. 3, depicting a masterless role-switch of a piconet composed of three slaves s1, s3, and s5 with AM_ADDRs 1, 3 and 5 respectively.

After T2(s1) overflows, s1 initiates the masterless role switching procedure, step 20.

s1 sends an FHS_packet to AM_ADDR=2, step 22. Since s3 and s5 receive the transmission, T2(s3) and T2(s5) are reset.

Since no slave has AM_ADDR=2, no response is transmitted. s1 sends an FHS packet to AM_ADDR=3, step 24. T2(s5) is reset. s3 responds to the FHS packet and begins the process of joining the new piconet, step 26.

T2(s5) is reset as a result of the last transmission associated with the joining of s3 to the piconet, step 28.

s1 sends an FHS_packet to AM_ADDR=4, step 30. T2(s5) is reset. Since no slave has AM_ADDR=4, no response is transmitted.

s1 sends an FHS_packet to AM_ADDR=5, step 32.

S5 responds to the FHS_packet and begins the process of joining the new piconet, step 34.

At the end of the process described above and depicted in FIG. 3, a new piconet is formed, where the former slave s1 is the master and the slaves s3 and s5 are slaves. Since the procedure described above is performed entirely at the Baseband layer, it is transparent to the higher layers of the Bluetooth protocol stack and, most importantly, to the application.

In principle, the Bluetooth protocol is designed with point-to-point communications in mind where one unit, the master, acts as the hub for all communications. Multi-user applications such as multiplayer games require point-to-multipoint communications with no apparent hierarchy. In such applications, a number of equivalent devices send messages addressed to each other, and from the point of view of the application, messages do not need to pass through the master of the piconet.

There are many possible methods to implement point-to-multipoint communications under the Bluetooth protocol. The second feature of the present invention relates to a method whereby point-to-multipoint communications are supported in a way that is transparent to the application and the application can continue running despite the unexpected loss of the piconet master.

The first aspect of the second feature of the present invention is the division of the application layer into two parts, the application itself and the application adaptation layer. The application adaptation layer is provided by, for example, the vendor of the Bluetooth device and provides an Application Programming Interface (API) as an interface with simple-to-use services. The API allows the application itself to consider the Bluetooth system as any output device and obviates the need for Bluetooth protocol expertise amongst application developers. The application is configured to maintain a list of simple names that identify the participants of the application. Further, the application is configured to append a header with the simple name of the source and the simple name of the destination, for example, an ASCII header of the form “unit X calling unit Y” to every packet generated.

Bluetooth devices configured according to the second feature of the present invention maintain an addressing list. The addressing list is accessible to all relevant layers of the Bluetooth protocol stack. Hereinbelow, the addressing lists will be described as being implemented as tables, although it is clear to one skilled in the art that the addressing list can be implemented in many ways.

Each record of the addressing lists corresponds to one of the other participants of the application and includes at least four fields: a unit name of the other participant, the LCID used by the L2CAP layer to identify the logical link to the other participant, the CH used by the L2CAP and LM layer to identify the other participant, and the AM_ADDR of the other participant, as assigned by the master of the piconet. In FIG. 4, the addressing lists of master m0 and three slaves s1, s3 and s5 of a piconet are depicted. The four units, m0, s1, s3, and s5 are known to the application as Max, Olly, Therese and Fay, respectively. FIG. 4a designates the table containing the piconet link information stored by m0; FIG. 4b designates the table containing the piconet link information stored by s1; FIG. 4c designates the table containing the piconet link information stored by s3; and, FIG. 4d designates the table containing the piconet link information stored by s5. The unit name in the addressing list is the same as the simple name that is available to the application.

When the piconet is formed and the application initialized, the master fills its addressing list with the necessary communication information. The master also informs each slave in the piconet what the AM_ADDR and unit name of every other participant is. The name of the other participants is necessary for use by the application of the slave. Slave devices do not use the AM_ADDR field of the addressing list.

Throughout normal operation of the application, the layers of the master consult the addressing list to transmit packets to the slaves and to relay packets addresses to one slave from another slave. An application of one slave generates a packet to which a header containing the unit name of the destination unit is appended. The packet is sent to the application layer of the master. There, the application layer forwards the packet to the correct slave by consulting the addressing list.

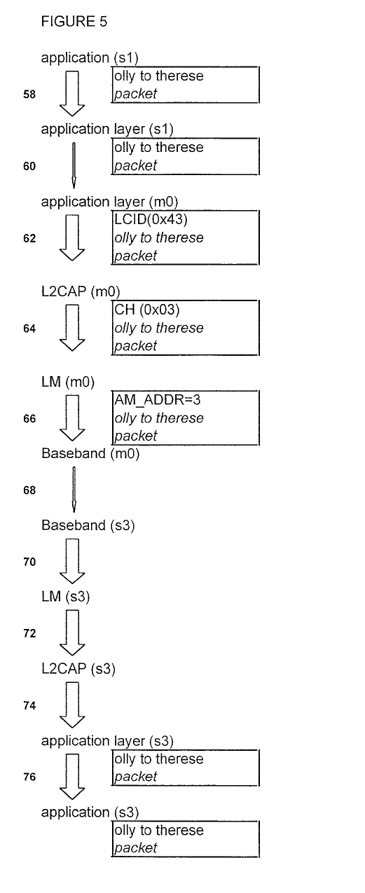

This process is schematically depicted in FIG. 5 for a piconet made up of a master m0 and three slaves s1, s3 and s5, using the addressing lists as appear in FIG. 4. In FIG. 5, narrow arrows signify transmission over the Bluetooth piconet whereas wide arrows signify transmission within a Bluetooth protocol stack of one device. The application of s1 generates a packet and appends a header “Olly to Therese”. The packet is sent to the application adaptation layer of s1, 58. Since the only communication channel possible for a packet from the application layer of a slave is to the application layer of the master, the application adaptation layer of s1 sends the packet to the application layer of m0, 60. The application adaptation layer of m0 reads the header, consults the addressing list, retrieves the LCID parameter associated with s3, appends the LCID to the packet and forwards the packet to the L2CAP layer of m0, 62. The L2CAP layer consults the addressing list, retrieves the CH parameter associated with s3, appends the CH to the packet and forwards the packet to the LM layer of m0, 64. The LM layer consults the addressing list, retrieves the AM_ADDR of s3, appends the AM_ADDR to the packet and forwards the packet to the Baseband layer of m0, 66. The packet is then transmitted to the application adaptation layer of s3 in the usual way, 68, 70, 72, and 74 successively. The application adaptation layer of s3 checks the header. Since the packet is intended for the application of s3, the application adaptation layer of s3 forwards the packet to the application of s3, 76. To the application, the existence of the piconet is not apparent at any stage.

If during the life of the piconet a standard master/slave role switch is performed, then during the transfer of information to the new master, the old master will transfer whatever information is necessary for the new master to fill out the addressing list.

If the master of the piconet unexpectedly disappears, the first step is the reconstitution of the piconet on the Baseband layer according to the first method the present invention, as described above. Once the new piconet is formed, it is necessary to update the addressing list stored by each member of the piconet.

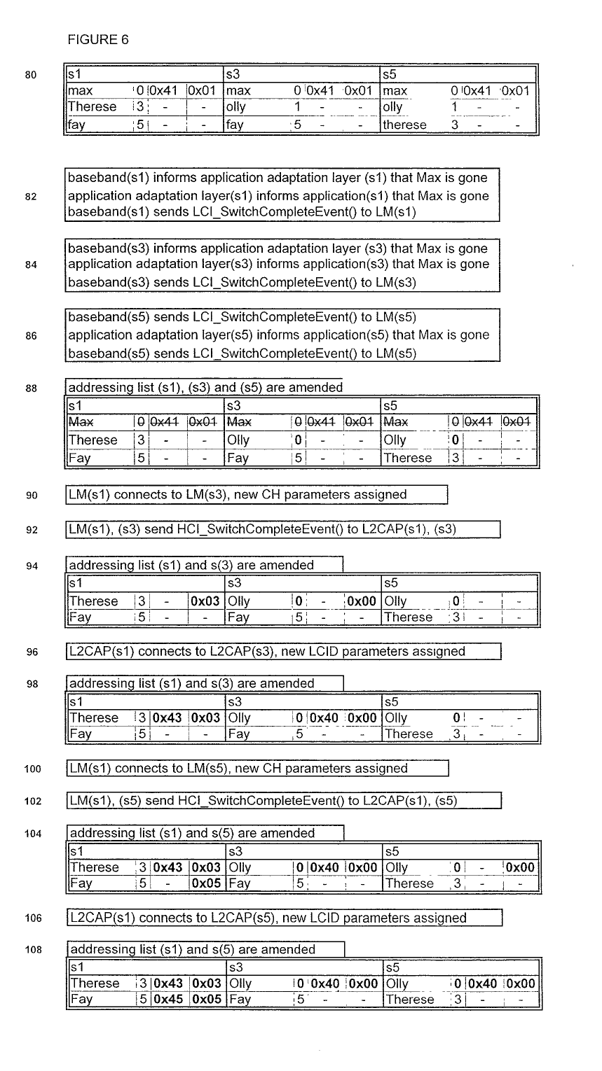

This updating process is schematically depicted in FIG. 6 for a piconet originally made up of a master m0 and three slaves s1, s3 and s5 using addressing lists as depicted in FIG. 4, 80 in FIG. 6. In FIG. 6, s1 becomes the master of a new piconet upon disappearance of m0. Although s1 can allocate any new AM_ADDR to the slaves of the piconet, the most preferable embodiment of the invention is depicted, where the slaves retain the AM_ADDR of the old piconet in the new piconet.

After m0 disappears, s1 initiates the masterless role-switch process as described above. Once the role-switch has been completed, the higher layers of the Bluetooth stack join the new piconet as depicted in FIG. 6. First, the Basebands of s1, s3 and s5 in step 82, 84 and 86, respectively, each informs its application adaptation layer that Max is no longer participating. The application adaptation layer of each unit informs its respective application that Max is no longer participating.

Further, the Baseband layer of s1, s3 and s5 each informs its respective LM layer of the switch. Although not defined in the standard Bluetooth protocol, for the present invention an LCI protocol is defined, being a communication protocol from the Baseband layer to the Link Manager layer. Within the LCI protocol is defined a LCI_SwitchCompleteEvent( ) message. The LCI_SwitchCompleteEvent( ) message is the message that the Baseband uses to inform its LM layer of a switch. As is clear to one skilled in the art, it is simple to implement such an LCI protocol.

The addressing lists of s3 and s5 are updated to indicate that Olly henceforth has AM_ADDR=0. The entry corresponding to Max is deleted from the addressing list of all piconet participants, 88.

As described, the process of adding the slaves to the new Bluetooth piconet proceeds serially. That is that the process is sequentially completed slave by slave, as is described hereinbelow.

First, the LM layer of s1 connects to the LM layer of s3. s1 and s3 both designate a new CH parameter to represent this connection, 90. The LM layer of s1 and the LM layer of s3 both send a HCI_SwitchCompleteEvent( ) message (see below) to the L2CAP layer of s1 and the L2CAP layer of s3, respectively, 92. The addressing lists of s1 and of s3 are accordingly amended 94.

As is clear to one skilled in the art, the HCI_SwitchCompleteEvent( ) message is not a message defined in the standard Bluetooth protocol but is a simple-to-implement command to allow performance of the teachings of the present invention.

Thereafter, the L2CAP layer of s1 connects to the L2CAP layer of s3. s1 and s3 both designate a new LCID parameter to represent this connection 96. The addressing lists of s1 and of s3 are accordingly amended 98.

Following completion of connection to the upper layers of s3, s1 continues to reestablish contact with the other slaves of the piconet. In the example discussed, the procedure of reestablishing higher layer connections and updating the addressing lists of s1 and s5 is done in a manner analogous to that described above for s3, and is depicted in FIG. 6, steps 100, 102, 104, 106 and 108.

In summary, for each device in the piconet:

Each time a slave is added to the new piconet at the Baseband layer as a result of the masterless role switch according to the invention, the Baseband layer of the new master sends the LM of the new master a notification packet, LCI_SwitchCompleteEvent( ), returning the AM_ADDR of the slave which has been added to the piconet. The Baseband layer of the slave sends the LM of the slave a notification packet, LCI_SwitchCompleteEvent( ), returning AM_ADDR=0.

Thereafter, sequentially for each slave:

the LM of the new master connects to the LM of the slave. This produces a new CH at each device, the CH being associated with the notified AM_ADDR. The LM of each device sends a notification event to the respective Device Manager, HCI_SwitchCompleteEvent( ). The addressing list of each device is then updated with the new CH.

The Device Manager of the new master then initiates an L2CAP connection with the slave L2CAP layer identified by the new CH. This action forms a new link (new master and slave) with a new LCID associated with the CH reported by the local LM. The addressing list of each device is then updated with the new LCID.

In the embodiment of the invention described above, where the slaves retain the AM_ADDR of the old piconet in the new piconet, then upon completion of the last step 108, the piconet is fully recovered despite the loss of the participant who was the master of the piconet. It is clear to one skilled in the art that in an embodiment where the new master allocates different AM_ADDR to the slaves, then the addressing lists of the slaves must be amended to include the new AM_ADDRs.

Recovery of the piconet is performed in a way that is completely transparent to the application.

In a piconet where both features of the present invention are supported then when the original master unexpectedly disappears all of the slaves have an addressing list containing the AM_ADDR of each participant. In an additional embodiment of the present invention where both features of the present invention are supported, the slave performing the masterless master/slave role switching only attempts to contact other units with the AM_ADDRs appearing in the addressing list.

Establishment of the new piconet as described above occurs serially, as communication between all layers of the Bluetooth protocol stack for one slave is established before establishing higher layer communications with another slave. It is clear to one skilled in the art that, alternatively, communications may be reestablished in parallel, where the master first completes establishing communications with one layer of all slaves before moving on to other layers.

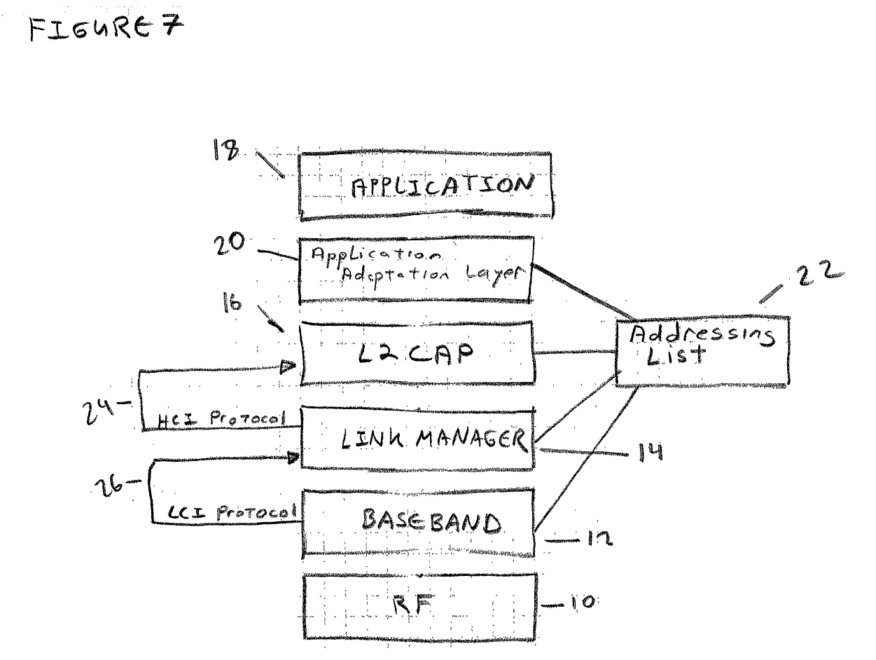

In FIG. 7, the protocol stack of a Bluetooth enabled device that is enabled to implement the second feature of the present invention is pictorially represented by depicting its modified protocol stack. Just as in every Bluetooth enabled device, there is found a RF transceiver 10, a Baseband layer 12, a Link Manager layer 14, a L2CAP layer 16 and an application layer 18. Interposed between L2CAP layer 16 and application layer 18 is an application adaptation layer 20, which operates as described hereinabove. Furthermore, there is an addressing list 22, accessible to Baseband layer 12 Link Manager layer 14, L2CAP layer 16 and application adaptation layer 20. In accordance with the Bluetooth standard, there exists an HCI protocol 24 allowing Link manager layer 14 to send messages to L2CAP layer 16. In addition, there exists a LCI protocol 26 allowing Baseband layer 12 to send messages to Link Manager layer 14. The operation of application adaptation layer 20, addressing list 22 and LCI protocol 26 are as described hereinabove. Just as with a standard Bluetooth protocol stack, each layer of the stack is implemented as hardware, software or a combination thereof.

While the invention has been described with respect to a limited number of embodiments, it will be appreciated that many variations, modifications and other applications of the invention may be made.

What is claimed is:

1. A method of establishing a new Bluetooth piconet amongst at least two slaves of an old Bluetooth piconet after a disappearance of an old master of the old Bluetooth piconet comprising:
a) determining that the old master has disappeared;
b) selecting one of the at least two slaves to be a new master; and
c) establishing the new Bluetooth piconet by said new master at a Baseband layer.

2. The method of claim 1 wherein said determining includes each of the at least two slaves independently waiting a respective period of time after cessation of transmissions from the old master, said each slave whose said period of time expires first then being selected as said new master.

3. The method of claim 2 wherein all said respective periods of time are predetermined.

4. The method of claim 3 wherein all said respective periods of time are identical.

5. The method of claim 2 wherein the at least two slaves are configured to start waiting said respective period of time each at a different moment.

6. The method of claim 2 wherein each slave of the at least two slaves includes:
a) a first timer set to overflow after counting a first period of time and to reset upon receipt of a transmission from the old master to respective said each slave
b) a second timer configured to start counting when said first timer overflows, to overflow after a second period of time and to reset upon receipt of transmission from the old master; and
wherein said respective period of time is a function of said first period of time and said second period of time wherein the slave whose second timer overflows first is selected as said new master.

7. The method of claim 6 wherein said second period of time is at least as great as said first period of time.

8. A method for establishing a new Bluetooth piconet amongst at least two slaves of an old Bluetooth piconet after a disappearance of the old master of the old Bluetooth piconet, each of the at least two slaves having a respective assigned old AM_ADDR from a plurality of AM_ADDRs, the method comprising:
a) selecting one of the at least two slaves to be a new master;
b) designating all other of the at least two slaves of the old Bluetooth piconet as new slaves;
c) transmitting by said new master of respective new communication parameters for the new Bluetooth piconet sequentially to each of said new slaves beginning at slots reserved for master transmissions using communication parameters of the old piconet; and
d) switching of each of said new slaves to said respective new communication parameters.

9. The method of claim 8 wherein said switching by each said new slave to said respective new communication parameters occurs upon receipt of said respective new communication parameters from said new master.

10. The method of claim 8 where for each slave of said at least two slaves includes:
a) a first timer set to overflow after counting a first period of time and to reset upon receipt of a transmission from the old master to respective said each slave; and
b) a flag, said flag set to TRUE when said first timer overflows and said flag set to FALSE upon receipt of a transmission from the old master;
wherein said switching by each said new slave to said new communication parameters occurs upon receipt thereof from said new master only if said flag is set to TRUE.

11. The method of claim 8 wherein said transmitting by said new master is performed to each AM_ADDR of the plurality of AM_ADDRs with the exception of the old AM_ADDR of said new master.

12. The method of claim 8 wherein said transmitting by said new master is performed only to old AM_ADDRs assigned to said new slaves.

13. The method of claim 8 wherein said new master assigns a new AM_ADDR to each of said new slaves, said new AM_ADDR being identical to the respective old AM_ADDR of each of said new slaves.

14. A Bluetooth enabled device configured to allow point-to-multipoint communications by an application between at least two units using a Bluetooth piconet comprising:
an application adaptation layer, said application adaptation layer configured to receive packets from the application wherein each of said packets is labeled with a name of a source unit and a name of a destination unit.

15 The device of claim 14 further comprising:
a local addressing list, said local addressing list containing a name and an AM_ADDR of all other units of the Bluetooth piconet, said addressing list being accessible to said application adaptation layer.

16. The device of claim 15 further comprising a L2CAP layer whereto said local addressing list is accessible, said local addressing list further including, for at least one other unit of the Bluetooth piconet, a LCID corresponding to a logical link between said L2CAP layer of the device and an L2CAP layer of said at least one other unit.

17. The device of claim 15 further comprising a LM layer whereto said local addressing list is accessible, said local addressing list further including, for at least one other unit of the Bluetooth piconet, a CH corresponding to a logical link between said LM layer of the device and an LM layer of said at least one other unit.

18. A method of restoring point-to-multipoint communications by an application between at least two units of an old Bluetooth piconet after disappearance of an old master thereof, comprising:
a) determining that the old master has disappeared;
b) selecting one of the at least two units to be a new master of a new Bluetooth piconet;
c) establishing said new Bluetooth piconet among the at least two units at a Baseband layer; and
d) establishing communications among the at least two units at at least one Bluetooth protocol stack layer higher than said Baseband layer.

19. The method of claim 18 further comprising informing the application of said disappearance of the old master.

20. The method of claim 18 further comprising said Baseband layer of each of the at least two units of said new Bluetooth piconet informing a respective LM layer that said new Bluetooth piconet has been established.

21. The method of claim 18 further comprising each LM layer of each of the at least two units of the said Bluetooth piconet informing a respective L2CAP layer that said new Bluetooth piconet has been established.

22. The method of claim 18, wherein said establishing communications among the at least two units is effected by said new master.

23. The method of claim 22, wherein said establishing communication among the at least two units is effected serially.

24. The method of claim 22, wherein said establishing communication among the at least two units is effected in parallel.

25. The method of claim 22, wherein said establishing communications is established at at least a LM layer and a L2CAP layer of said Bluetooth protocol stack.

26. The method of claim 25, wherein said establishing communication at said LM layer is effected prior to said establishing communication at said L2CAP layer.
